(19) United States
(12) Patent Application Publication
(10) Pub. No.: US 2010/0017893 A1
(43) Pub. Date: Jan. 21, 2010

(54) System for Securing Register Space and Method of Securing the Same

(75) Inventors: Denis Foley, Shrewsbury, MA (US); Aris Balatsos, Markham (CA)

Correspondence Address: ADVANCED MICRO DEVICES, INC.;C/O VEDDER PRICE P.C., 222 N.LASALLE STREET, CHICAGO, IL, 60601, US

(73) Assignees: ATI Technologies ULC, Markham (CA); Advanced Micro Devices, Inc., Sunnyvale, CA (US)

(21) Appl. No.: 12/176,580

(22) Filed: Jul. 21, 2008

(51) Int. Cl. G06F 1/26

(52) U.S. Cl. 726/34

(57) ABSTRACT

A system includes a processing device, at least one data processing module, and a security control module. The security control module is operatively connected to both the processing device and the data processing module. The security control module is operative to control access to a protected register that is associated with the at least one data processing module. As such, the security control module operates as a firewall or filter to allow or deny access to a protected register. Security-unaware data processing module are therefore secured in the system at a central location while eliminating the need to use only security-aware data processing module. A method for securing data processing modules, including security-unaware data processing module, is also disclosed.

### BACKGROUND OF THE INVENTION

With significant improvements in processing capabilities, portable electronic devices, such as personal computers, cell phones, PDAs, and other common devices, are being deployed in an ever expanding array of applications. The ubiquitous cell-phone, for example, has emerged in a multi-function role as a communications device, still and video camera, media playback center, point of sale terminal, personal digital assistant, GPS, and a browser terminal enabling web access.

The expanded suite of applications introduces a host of new types of stored or streamed data that has to be handled by the device. Examples might include personal data (e.g., contacts, passwords, financial data) and protected Digital Rights Media (e.g., videos, music, streamed broadcast of TV, premium GPS content such as maps and location based service data, games, and licenses for playback of said protected data).

The expanded array of services, applications, and connectivity also dramatically increase the risk of attack either through physical theft of the device, or through the introduction of malware designed to expose protected material. Frequently, in the case of the protected Digital Rights content, the device owner may also be the primary suspect for attempted content piracy. Increasingly, cell phone manufacturers, carriers, content providers, and the end customer are demanding that the cell-phone provide a thoroughly secure computing environment.

Compounding the issue for cell-phone manufacturers is the sheer size of modern operating systems (e.g., Linux and Windows). Most exploitable backdoors in modern computers today take advantage of programming errors, which are more common in larger operating systems.

One approach to securing the cell-phone is to derive the concept of two execution environments on the phone—a secure execution environment where sensitive data can be handled and stored and a non-secure execution environment where protected data is not exposed and a non-secure execution environment accessible to all applications. Code execution in the non-secure environment is prevented from accessing data protected in the secure environment. Only software that is verified and trusted runs in the secure execution environment.

The dual execution environment can be implemented in a number of ways. One approach is to have two distinct processing solutions (processors, memory and IO) such that one device is deemed the secure processor and has responsibility for dealing with any data requiring protection. A second processor runs non-secure applications. If a non-secure application has a requirement for data manipulation of secure data, it can make a request to the secure processor, which then handles the function. One example of this might be a non-secure application (e.g., a video playback application), which makes a request of the secure processor to validate license rights, authenticate, decrypt, decode, and playback a video file. The secure processor can run the software necessary to validate the license rights to play back the video, can perform the decryption of the video data, can decode the cleartext (decrypted) video data, and can render the video to a display. All the while, the secure processor ensures that no keys (used for authentication) or cleartext video data (the protected Digital Right Content) is exposed to the non-secure processor.

It is noted that some processors, such as some ARM® (ARM is a registered trademark of ARM Ltd.) processors, are designed to operate as either a secure processor in a secure mode or an unsecure processor in an unsecure mode. This dual-function mode of operation allows the same physical hardware to act in either capacity while still protecting secure content for exposure to non-secure applications.

Methods and systems are also known that protect memory spaces from unsecure applications. Such systems, for example, may define areas of the physical memory to be secure. If the processor is running in a secure mode, however, then an application may have access to any memory space. Protecting memory space alone, however, is not-sufficient. Device registers (including those used to define the secure memory spaces) may also need to be protected in order to ensure that they cannot be reconfigured to expose protected memory content. Further complications arise if a plurality of control processors have access to system memory and register resources.

Another example of a known system for providing security is shown in FIG. 1. System 100 includes a processing device 102 operatively connected to bus 104 such that processing device data 106 may be passed between the processing device 102 and the bus 104. Processing device 102 may include one or more central processing units (“CPUs”), graphics processing units (“GPUs”), one or more CPU cores, one or more GPU cores, distributed processing circuitry, application specific integrate circuits (“ASICs”), state machines, discrete logic, or any other suitable processing device (or circuitry) known in the art.

A baseband interface 108 may also be attached to bus 104 to communicate with devices via a radio signal, providing and receiving baseband interface data 109. The baseband interface, for example, communicates with a chip that contains a radio chip that has the function of communicating with a cell tower to initiate/receive a call. One class of operations that the radio chip might request of a multimedia chip is a request to initiate a ring tone playback in response to an incoming call. Baseband interface 108 contains processing device 102 (e.g., control logic), which functions as control logic for the basedband interface 108. It is understood that processing device 102 that is within baseband interface 108 may be control logic that serves as a proxy to an external master processor. The baseband interface 108 is operatively connected via connection 111 to another device 113, which may be an external device with respect to the baseband interface 108. Connection 111 may be any suitable connection, such as a wired connection, radio signal, wireless connection, a series of networks, or any other suitable connection. It is further contemplated that device 113 may not be directly coupled to the baseband interface 108 but may instead be operatively coupled to baseband interface 108 via other devices (not shown). Processing device 102 on device 113 may communicate with bus 104 via the baseband interface 108.

In system 100, processing device 102 may operate in a secure mode or an unsecure mode. Secure data processing modules 110, which may be peripheral interfaces that pass secure peripheral interface data 112 to and from bus 104, are any peripheral interfaces that are trusted as being secure and may not be accessed by an application running on a processing device 102 when the processing device 102 is in an unsecure mode. It should be noted that the processing device 102 may be made secure with respect to bus 104 if it is an “on-chip” module, but if it is “off-chip,” e.g., such as processing device 102 in device 113, it cannot generally be treated as secure since the data it provides can be exposed to hackers via the external connection 111 and compromised. Thus, data from device 113 is not immediately trusted, although it is recognized the data may be authenticated via cryptography.

The secure data processing modules 110 have some type of security protection built in. Peripheral interfaces may include any additional interface or chip ultimately connected to the processing device 102 through various communication paths, such as busses or a network (wired or wireless).

In one example, bus 104 may include a control signal that indicates whether the processing device 102 is operating in a secure mode or an unseucure mode. If an access request is made to a secure peripheral device 110, the secure peripheral device 110 will deny the request if the processing device 102 is operating in an unsecure mode.

Bus 104 is operatively connected to another bus 114 via bridge 116. A bridge 116 is used to transition bus access from one bus segment to another by appropriate translation of bus access protocol and bus characteristics (e.g., speed and voltage) to permit proper communication between the bus segments. It is understood that bridge 116 may not exist or that several other busses (not shown) may exist. A direct memory access engine (“DMA engine”) 118 and a memory controller (“MC”) 120 are operatively connected to bus 114 (and thus also operatively connected to processing devices 102 and 110). Data processing modules, such as peripheral interfaces 122, are also operatively connected to bus 114. Data processing modules “handle” data. For example, data processing modules may move or copy data, manipulate data, or perform any other suitable operation on data. For example, peripheral interfaces 122 are data processing modules that may send and receive peripheral interface data 123 to/from bus 114. It is understood that although many of the examples disclosed herein refer to peripheral interfaces 122, the concepts could be applied to any suitable data processing module, such as DMA engine 118, memory controller 120, or even another processing device down-stream of a master processor. Unlike the secure peripheral interfaces 110, which are also data processing modules, peripheral interfaces 122 may not have any concept of security. The peripheral interfaces 122 may be designed and/or manufactured by a third party that is not concerned about security, or the peripheral interfaces 122 may have been designed at a time when security was not a major concern as it is today.

In one example, memory controller 120 is operatively connected to memory 124 and is operative to send and receive memory data 126 to and from memory 124. Memory 124 may be any type of memory conventionally known in the art, such as random access memory (RAM), read-only memory (ROM), programmable memory (PROM), erasable PROMs (EPROM), electrically erasable PROM (EEPROM), flash memory, magnetic storage devices (e.g., hard disks, floppy disks, magnetic tape), optical disc drives, or any other suitable non-volatile memory now known or later developed. It is further recognized that memory 124 may be distributed.

It is also known that memory 124 may have a region of secure memory 128. Various techniques are known for defining regions of secure memory, in addition to controlling access to the region of secure memory 128. Thus, for example, a peripheral interface 122 may be attached to a peripheral (not shown), such as a USB device, a UART device, an SD/SDIO/MMC/CE-ATA channel device, a NAND flash support device, a SPI interconnect device, an I2S device, an I2C device, or any other suitable input/output (“I/O”) peripheral device or interface. To protect data from a peripheral interface 122, for example, registers (not shown in FIG. 1) associated with the peripheral interface 122 may designate the memory location to which data from the peripheral interface 122 should be placed. This memory location may be a region of secure memory, and as such, the data is secured. If the registers describing the address location for which the peripheral interface's 122 data should be placed are changed, however, the data may be compromised and written to an unsecure region of memory.

One solution to this problem is to use only peripheral interfaces 122 that are secure (i.e., implemented as secure data processing modules 110). This solution, however, is inadequate because it may require additional design work to create new peripheral interfaces 122 that do not yet exist. When systems contain a large number of interfaces, securing all interfaces becomes problematic.

A need therefore exists to further secure data in an electronic system, and more particularly to secure critical registers that help direct data flow to ensure that the critical registers are not compromised and altered to redirect secure data to an unsecure location.

### BRIEF DESCRIPTION OF THE DRAWINGS

The invention will be more readily understood in view of the following description when accompanied by the below figures and wherein like reference numerals represent like elements, wherein:

FIG. 1 is a block diagram showing an example of a prior art system;

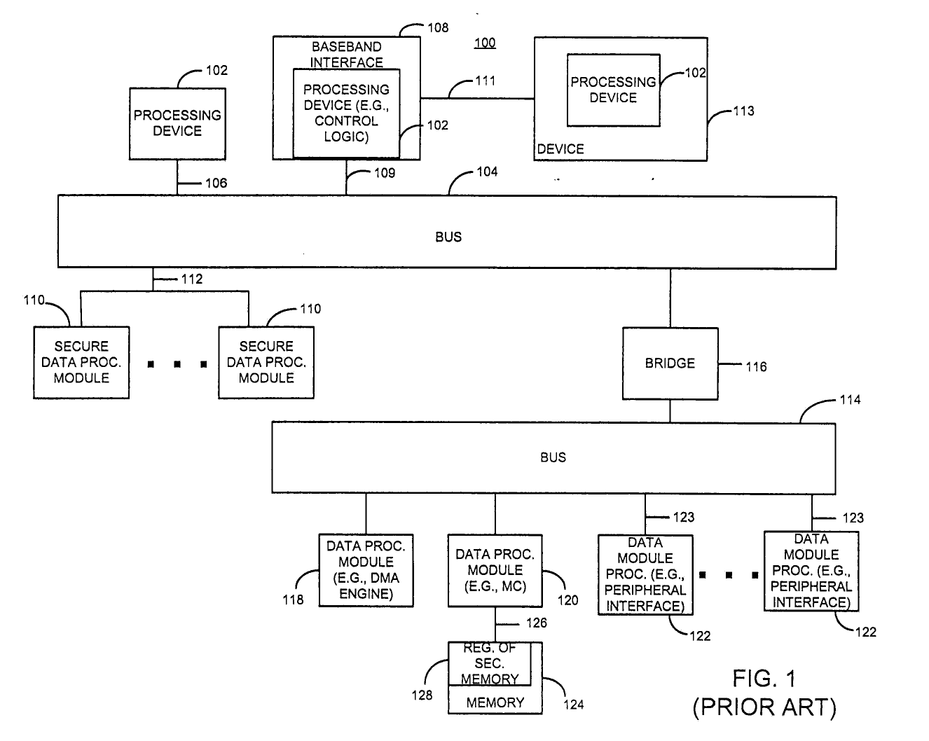

FIG. 2 is a block diagram showing an example of a system having a security control module;

FIG. 3 is a block diagram showing the example system of FIG. 2 further showing more detail of one example of the security control module;

FIG. 4 is a block diagram showing one example of a system having an integrated circuit that includes a security control module;

FIG. 5 is a flowchart showing one example of a method for securing peripheral interfaces; and

FIG. 6 is a flowchart showing an example method for securing peripheral interfaces.

FIG. 7 is a block diagram showing another example of a system having a security control module.

### DETAILED DESCRIPTION OF THE PREFERRED EMBODIMENTS

In one example, a system includes a processing device, a data processing module, a protected register associated with the data processing module, and a security control module. The security control module is operatively connected to both the processing device and the data processing module. The security control module is operative to control access to a protected register that is associated with the data processing module. In other words, the security control module operates as a firewall or filter to allow or deny access to a protected register. As such, security-unaware data processing modules may be secured in the system at a central location while eliminating the need to use only security-aware data processing modules.

Among other advantages, the system provides a central location for securing data processing modules in a system by securing registers associated therewith. As such, confidential information and/or information subject to copyright laws may be protected without requiring only security-aware data processing modules. By providing a centrally located solution to control access to potentially vulnerable registers, even security-unaware data processing modules may be secured. In addition, security can be provided for other purposes, such as preventing malware running on non-secured processors from accessing key system registers that can lead to denial of service whereby the system is forced into an inoperable state. For example, the secure system can be used to protect registers that control clock generation or power distribution in the system. Other advantages will be recognized by those having ordinary skill in the art.

In one example, the security control module includes control logic and a register exclusion table. The register exclusion table, which may be implemented in hardware, contains at least one address associated with a protected register that is associated with a data processing module. If a request is made to the protected register from a processing device operating in an unsecure mode, the request is denied.

In one example, an accessing client, such as an application (i.e., stored computer readable and executable instructions) executing on a processing device, may access the protected register if the processing device is operating in a secure mode. If the processing device is operating in an unsecure mode, the processing device (and as such, the accessing client running on the processing device) will not have the ability to access or change the protected register. This ability to access the protected register is controlled by the security control module.

In yet another example, a system further includes a secure region of registers, i.e., a map or zone defining one or more registers (e.g., a region of registers in register space) that can further define a register as being secure. Thus, for example, if a register should be protected but is not included in the register exclusion table, the register (or a region of registers including the register) could be added to the secure region of registers. This may be done by a software application running on a processing device in a secure mode. It should be noted that having a register in the register exclusion table means that a reference capable of identifying the register is in the table, such as an address of a register.

A method is also disclosed for securing data processing modules operatively connected to a bus. The method includes, among other things, receiving an access request from a processing device. An application, i.e., stored computer readable instructions executing on a processing device, may cause the processing device to make such a request. A determination is made as to whether the requested register is a protected register. Additionally, a determination is made as to whether the source of the request (e.g., the processing device) is operating in a secure mode. This may be accomplished, for example, by monitoring a security attribute hardware signal on a bus. Access to the protected register is then controlled based on whether the requested register is a protected register and whether the processing device is operating in a secure mode. More particularly, the access is denied if the requested register is designated as a protected register and if the accessing client is unsecure (e.g., if the accessing client is an application running on a processing device operating in an unsecure mode).

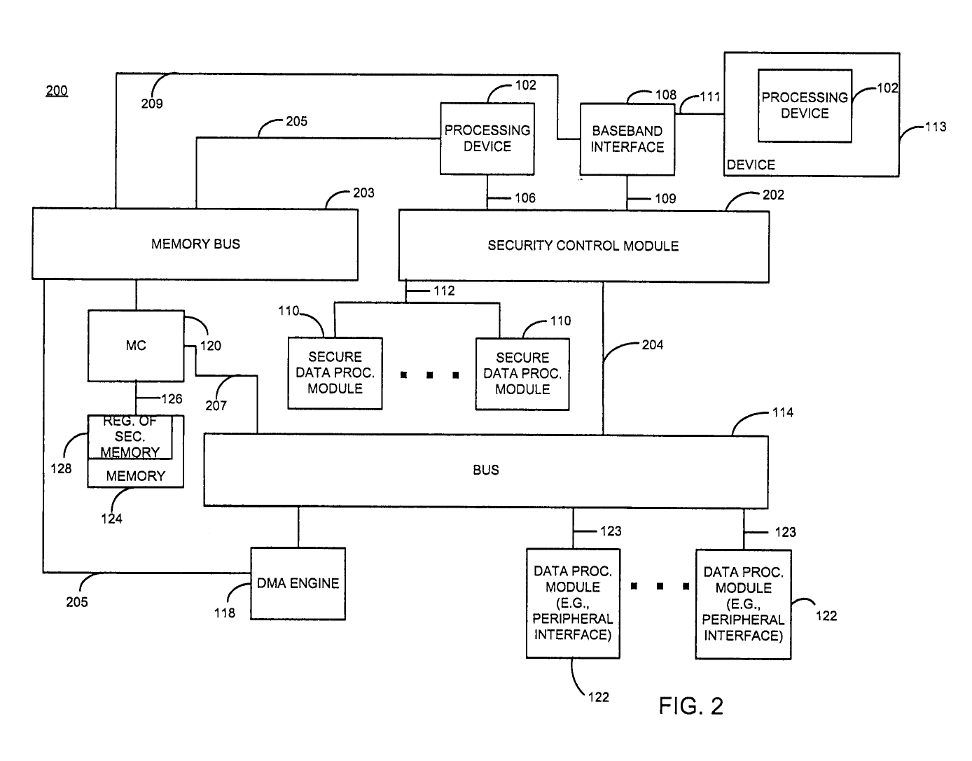

Referring now to FIG. 2, a system 200 is shown, which may be in, or part of, any suitable electronic device. The system includes a processing device 102, a baseband interface 108, and a security control module 202. Processing device 102 is also operatively connected to a memory bus 203 by connection 205. Memory bus 203 is operatively connected to memory 124. Baseband interface 108 is operatively connected to the security control module 202 via connection 109 and to memory bus 203 via connection 209.

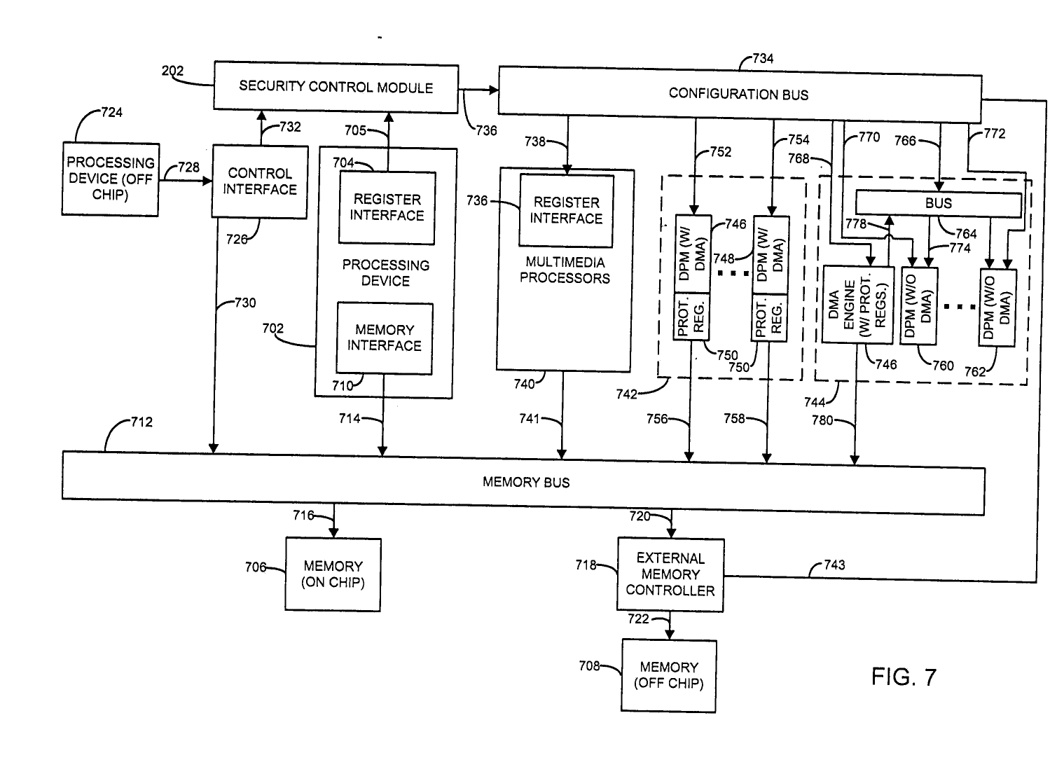

The security control module 202 is operatively connected to processing device 102 in one example. Bus 114 and security control module 202 are operatively connected via connection 204. It is understood that security control module 202 may be operatively connected to processing device 102 by any suitable means, which may include intervening buses or a direct connection as shown. The security control module 202 sends and/or receives security control module data 204 to and from the bus 114, which is a control bus in this example. Bus 114 is operatively connected to several data processing modules, such as DMA engine 118, a memory controller 120, and at least one peripheral interface 122. Although not shown until FIG. 7, a data processing module may also include any additional processing device that is “down stream” from a master processing device but located after the security control module 202. Bus 114 is also operatively connected to memory controller 120 via connection 207. It should be understood that data on bus 114 is control/configuration information (e.g., register data), while data on bus 203 is data such as executable code, stored memory data, etc.

The data processing module, such as peripheral interface 122, may be any additional interface, chip, integrated circuit designed to perform any suitable function for an electronic device, such as moving data, copying data, manipulating data, processing data, or performing any other suitable function. A peripheral interface 122 may be external or internal to a device, but in a preferred embodiment, peripheral interfaces 122 are within the electronic device. Peripheral devices (not shown) may then operatively connect to a peripheral interface via a physical connection, a wireless connection, or any other suitable connection. Peripheral interfaces 122 include, for example, a USB device/host controller interface, a UART interface, an SD/SDIO/MMC/CE-ATA channel interface, a NAND flash support interface, a SPI interconnect interface, an I2S interface, an I2C interface, or any other suitable I/O peripheral interface. Peripheral devices include, for example, a UART connected console, SD/MMC/CE-ATA or NAND connected flash mass storage device, SPI or SDIO connected communication device (e.g., WLAN device), or an I2S connected Audio Analog Front-End (DAC/ADC).

The security control module 202 operatively connects the processing device 102 and a data processing module, such as DMA engine 118, memory controller 120, and peripheral interfaces 122, among other things. The security control module 202 is operative to control access to a protected register associated with the data processing modules. The protected register is a control register. Note that the protected register is defined as a protected register because the security control module 202 controls and limits access to it. A “protected register” is not otherwise different than a “non-protected register.” Security control module 202 may control access to any other suitable register, even if not associated with a data processing module, as desired to improve security in system 200.

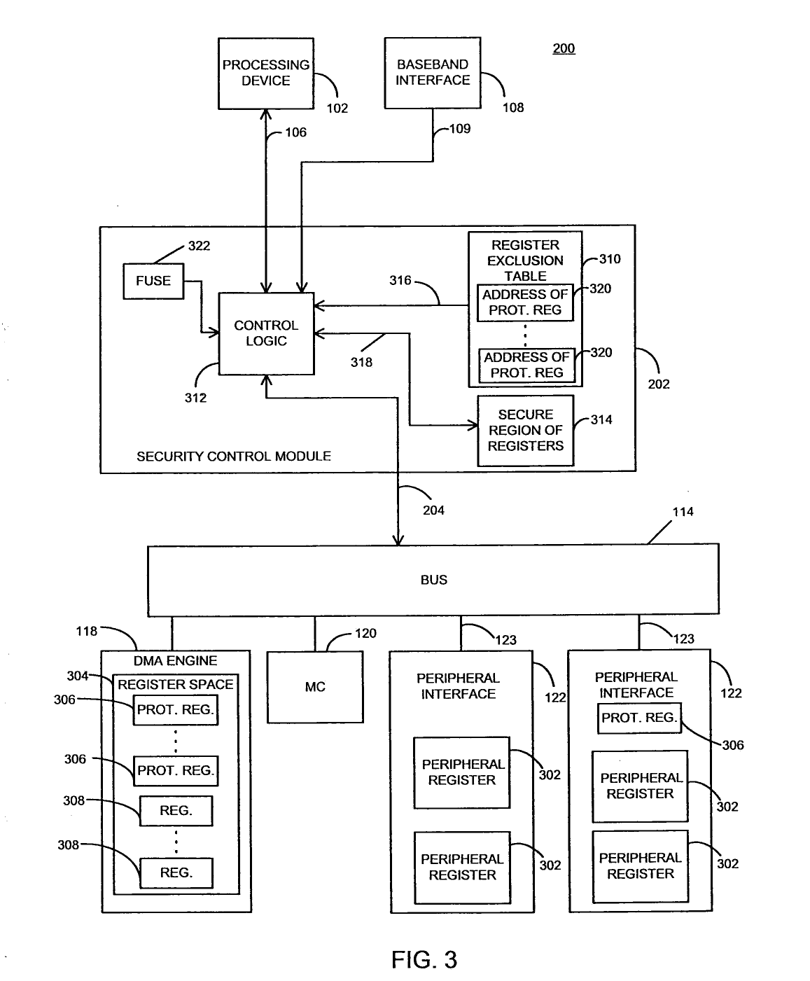

Turning now to FIG. 3, security control module 202, DMA engine 118, and peripheral interfaces 122 are shown in more detail. Registers, such as configuration registers, are located throughout system 200. As shown, peripheral interface 122 includes peripheral registers 302 and may contain protected registers 306. Peripheral registers 302 and 306 may contain configuration information used to define the interface capabilities and function in the system including, but not limited to, bus widths, bus speeds, interrupt configurations, packet transfer sizes, and other suitable characteristics known to one having ordinary skill in the art. Although shown as being located within the peripheral interfaces 122, it is understood that peripheral registers 302 may be located in any suitable location. It is further understood that a peripheral interface 122 may contain a mix of registers whereby some are protected, all are protected, or none are protected.

In one example, DMA engine 118 and memory controller 120 may also contain configuration registers 308 and protected configuration registers 306. In the case of the DMA engine 118, the registers 308, 306 convey information such as the source and destination address for the data transfer. In the case of the memory controller 120, the configuration registers 308, 306 contain information relating to the configuration of memory controller 120, such as the arbitration priority schemes to use and the memory speeds supported as well as other configuration information known to one of ordinary skill in the art. In addition, memory controller 120 can contain protected registers 306, which define which regions of memory are secure. Protected registers 306 and unprotected registers 302, 308 are no different from each other except that access to protected registers 306 is controlled through security control module 202. In other words, both protected registers 306 and unprotected registers 302, 308 may be the same as viewed from the perspective of bus 114, but when viewed from the perspective of the processing device 102, the security control module 202 will deny an access request to a protected register 306 by the processing device 102 if the processing device 102 is operating in an unsecure mode. This is because, as described below, the address of each protected register 306 is in the register exclusion table 310.

In operation, for example, the DMA engine 118 is operative to move data between memory 124 and peripheral interfaces 122 that do not support their own integrated DMA engine. The source and destination addresses used by the DMA engine are contained in protected registers 306. By protecting these source and destination addresses, access to secure memory 128 by peripheral interfaces 122 can be limited to only those devices that are trusted. Peripheral interfaces 122 with their own integrated DMA engines have a connection (not shown) to the memory bus 203 operative to move data between the peripheral interface and the memory 124 and have similar source and destination address registers similarly implemented as protected registers 306. It is understood, however, that registers 302, 306, 308 may be located in any other suitable location within system 200.

Protected registers 306 are protected to prevent unauthorized access of data that should not be intercepted. For example, the data may be subject to copy right laws or may represent confidential information. Thus, any register 306 that is associated with a peripheral interface 122 that controls data access may be a protected register. For example, a protected register 306 may contain the address for the base address to which data from a peripheral device should be written. In one example, the base address in the protected register 306 may be an address of memory that is located in a region of secure memory 128. A DMA helps limit the access a peripheral can have to the system memory space as address information is contained within the DMA, so by securing the DMA, if the DMA moves secure data, it will never be fooled to access secure memory on behalf of a rogue application on a non-secure data processing device.

If a rogue application running on the processing device 102 is allowed to change the address within protected register 306, then the system 200 may allow a DMA engine 118 to move data that should only be written to a region of secure memory 128 to a region of unsecure memory, which could then allow an unauthorized application to copy the data.

The protected register 306 may also contain any other suitable value related to the peripheral interface 122 that could lead to a security risk if changed. For example, the value of the protected register 306 may be an offset register that affects the length of a data transfer. If the data transfer length is increased, the transfer may end up transferring secure data. In such an example, the peripheral interface 122 register defining the length of the transfer would be classified as a protected register 306 and could only be modified by the processing device 102 operating in a secure mode.

The security control module 202 acts as a firewall or filter that prevents an application (i.e., computer readable instructions executing as an application the processing device 102, which may be comprised of one or more CPUs, for example), from accessing or changing the value stored in a protected register 306 unless the processing device 102 is operating in a secure mode. For example, an accessing client may be anything attempting to access something operatively connected to bus 114. For example, an accessing client may be an application running on the processing device 102, i.e., stored executable instructions executing on processor 102. When the processing device 102 is operating in a secure mode, the accessing client and processing device 102 may access a protected register 306. If, however, the processing device 102 is operating in an unsecure mode, the accessing client and processing device 102 will not have the ability to access a protected register 306. This access ability is controlled by the security control module 202.

In one example, the processing device 102 may be two CPUs, with one CPU operating as a secure processing device and the second CPU operating in an unsecure mode. In one embodiment, the processing device 102 is one CPU capable of transitioning between a secure mode and an unsecure mode. In the secure mode, the processing device 102 typically runs code that is trusted and that has been fully tested and is unlikely to have vulnerabilities that could allow system 200 to be compromised. Applications that run in secure mode, therefore, are highly trusted and as such, have the ability to do more in the system, such as access protected registers 306.

In the unsecure mode, however, other more diverse code may be run, which allows system 200 to perform a much larger set of tasks. This diverse code is more prone to having security vulnerabilities that could be exploited to compromise data, among other things. As such, when the processing device 102 operates in an unsecure mode, the processing device 102 may be able to run a wider range of applications, but the processing device 102 will be limited as to what portions of the system 200 it may access if access. As one example, protected registers 306 would not be accessible as that access could create a security breach.

Referring to FIG. 3, security control module 202 includes control logic 312, a register exclusion table 310, and a secure region of registers 314. Control logic 312 is operatively connected to processing device 102, register exclusion table 310, secure region of registers 314, and at least one peripheral device 122 (or memory controller or DMA engine, or any other suitable device, which may contain a register) (which may be via bus 114). Control logic may read register exclusion table values 316 from the registration exclusion table 310 and may read and/or write secure region of registers values 318 to the secure region of registers 314. In one embodiment, the address filtering performed by the security control module is performed as a single logical operation by comparing the address from the processing device 102 with a single logical representation of the entirety of the register address 320 protected by the register exclusion table 310 and the register address additionally defined in the secure region of registers 314. It is understood, however, that control logic 312 may be operatively connected in any suitable configuration. For example, control logic 116 could be directly connected to bus 114 or may have other busses between itself and the data processing modules.

The registration exclusion table 310 contains at least one address 320 associated with a protected register 306. The addresses 320 are stored permanently in the register exclusion table 310 and cannot be changed. In operation, control logic 312 receives an access request to a requested register, which may be any register in system 200, such as a protected register 306 or an unprotected register 308. If the processing device 102 is operating in an unsecure mode, the control logic determines if the address of the requested register is in the register exclusion table 310 as being an address of a protected register 320. If the requested register is listed as an address of a protected register 320 and the processing device 102 is operating in an unsecure mode, the control logic 312 denies the access request using a mechanism agreed upon between the processing device 102 and the security control module 202. One such mechanism is by returning an error response on the bus 106. If, however, the processing device 102 is operating in a secure mode or the accessing client is deemed a trusted client, then the access request is permitted, regardless of whether the requested register's address is in the register exclusion table 310.

Security control module 202 also contains a software-defined exclusion table, formed by a secure region of registers 314, which may correspond to a data processing module, such as a peripheral interface. More specifically, the secure region of registers 314 may contain, for example, a range of addresses of registers 308 that should be secure, even though the addresses were not included in the register exclusion table 310. For example, a hardware designer may compile a list of critical registers associated with a peripheral interface 122 that should be protected in order to secure any data associated therewith. These registers may then be placed in the hardware-implemented register exclusion table 310. After building system 200 and the permanent register exclusion table 310, however, it may be realized that the hardware designer did not include one or more registers that should have been protected, thereby leaving a potential security risk. In such cases, software may define additional protected registers in the secure region of registers 314. It is contemplated in another example embodiment could have a secure region of registers 314 and not have a register exclusion table 310.

The secure region of registers 314, however, may be programmed to include a register or a range of registers that are also protected registers. The control logic 312, therefore, not only checks to see if a requested register's address is located in the register exclusion table 310 but also determines if the requested register's address is included in the secure region of registers 314, which could include, for example, a range of protected registers. For example, a range of addresses could be set that protects all registers associated with a peripheral interface 122. It is understood that the security control module 202 may contain more than one secure region of registers 314. Thus, control logic 312 may not only deny an access request to a register with its address included in the register exclusion table 310 but also deny an access request if the processing device 102 is operating in an unsecure mode and the requested register's address is included in the secure region of registers 314 (possibly within a range of addresses of registers that should be protected).

Unlike the register exclusion table 310 which is permanently implemented in hardware in a preferred embodiment, the secure region of registers 314 may be changed. However, to protect the integrity of system 200, is should be recognized that the values in the secure region of registers can only be changed when processing device 102 is operating in a secure mode 102.

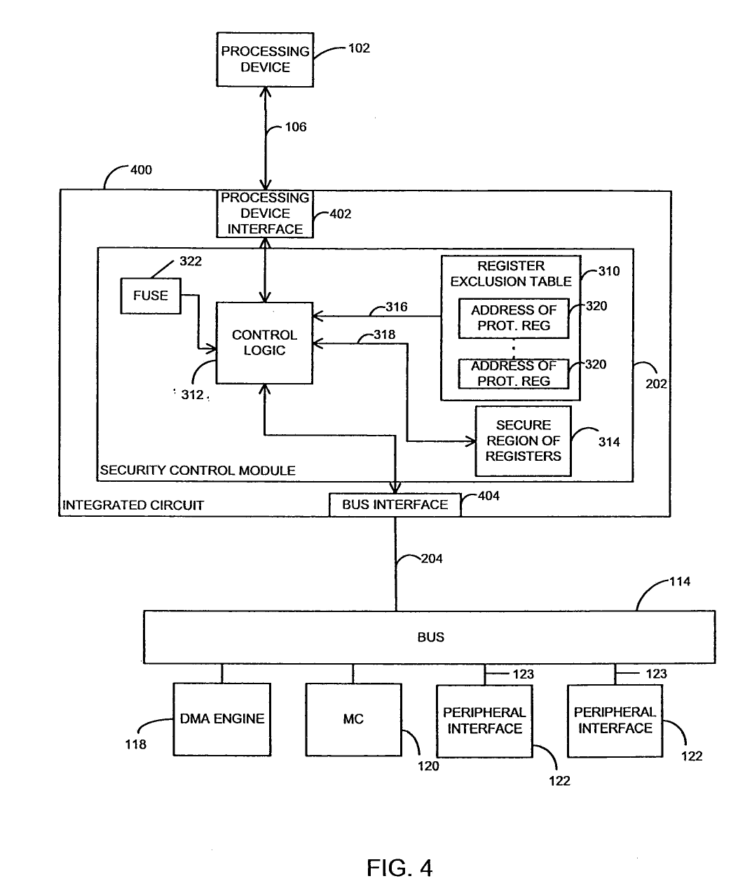

Turning now to FIG. 4, an integrated circuit 400 is shown. The integrated circuit 400 includes a processing device interface 402, a bus interface 404, and a security control module 202. The processing device interface 402 operatively connects the security control module 202 (and thus the integrated circuit 400, as well) to a processing device 102. The bus interface 404 may operatively connect a bus 114 (or a bridge or at least one data processing module) to the security control module 202 (and thus to the integrated circuit 400, as well).

The integrated circuit 400, when operatively connected to a processing device 102 and at least one peripheral device 122, controls access by the processing device 102 to a protected register associated with bus 114. The protected register may further be associated with a specific peripheral interface 122, or any other suitable data processing module, that is either directly connected to the bus interface 404 or to a bus 114 operatively connected to bus interface 404.

The components and operations of the integrated circuit 400 will be understood in view of the description above relating to system 200 and the security control module 202. For example, the security control module 202 contains control logic 312 operatively connected to both the processing device interface 102 and the at least one bus interface 404. Security control module 202 also contains a register exclusion table 310 and a secure region of registers 314. The control logic 312 is operative to receive an access request to a requested register from the processing device interface 402. If the control logic determines that the address of the requested register is in the register exclusion table 310 for being a protected register and determines that the access request is generated by a processing device 102 operating in an unsecure mode, the control logic 312 is operative to deny the access request.

FIG. 7 shows a preferred system 700 incorporating a security control module 202. Processing device 702 includes a register interface 704 that communicates with security control module 202 via connection 705. The register interface 704 sends data associated with registers only, i.e., it does not send data to/from on-chip memory 706 or off-chip memory 708. Instead, memory interface 710 of processing device 702 is operatively connected to memory bus 712 via connection 714. Although not shown, memory bus 712 may additionally be operatively coupled to a bus arbiter, a memory controller, or any other suitable component known in the art. Data may then move to/from on-chip memory 706 via connection 716. Alternatively, external memory controller 718, connected to memory bus 712 via connection 720, may be operatively connected via connection 722 to off-chip memory 708.

An off-chip processing device 724 is also operatively connected to the security control module 202. In this example, the off chip processing device 724 is operatively connected to a control interface 726 via connection 728. Control interface 716 may be a processing device and contains any suitable logic. The control interface 726 communicates with memory bus 712 via connection 730 and communicates with security control module 202 via connection 732.

The security control module 202 functions as described above. It communicates with a configuration bus 734 via connection 736. The configuration bus is operatively connected to registers, namely configuration registers, associated with data processing modules. For example, configuration bus 734 is connected with a register interface 736 via connection 738. The register interface 736 stores values for one or more multimedia processors 740. Multimedia processors may include, for example, an audio processor, a video processor, a function for processing camera data, or a vector graphics function. Furthermore, multimedia processors 740 are operatively connected to memory bus 712 via connection 741. The configuration bus 734 is also operatively connected to external memory controller via connection 743.

Two other examples of data processing modules are grouped by dotted lines 742 and 744. The group within dotted line 742 contains data processing modules (labeled “DPM”) 746 and 748 (e.g., a peripheral interface) that have DMA built in. As such, the data processing modules 746 and 748 have at least one protected register 750 (and possibly unprotected registers, not shown). The data processing modules 746 and 748 are operatively connected to configuration bus 734 by connections 752 and 754. The data processing modules 746 and 748 are also operatively connected to memory bus 712 by connections 756 and 758 for memory data movement.

In contrast, the data processing modules 760 and 762 within dotted line 744 do not have DMA built in, and as such a DMA engine 746 is included and is operatively connected to data processing modules 760 and 762. Configuration bus 734 is operatively connected to bus 764 via connection 766, to DMA engine 746 via connection 768, and to data processing modules 760 and 762 via connections 770 and 772. The data processing modules 760 and 762 are operatively connected to bus 764 via connections 774 and 776. DMA engine 746 is operatively connected to both bus 764 via connection 778 and memory bus 712 via connection 780.

In one example, processing device 702 sends a request to change a protected register in DMA engine 746 to the security control module 202. If processing device 702 is operating in a secure mode, the security control module passes the desired change to configuration bus 734, which in turn changes the protected register in DMA engine 746. If, however, processing device 702 is operating in an unsecure mode, the security control module will deny a request to change a protected register associated with the data processing modules.

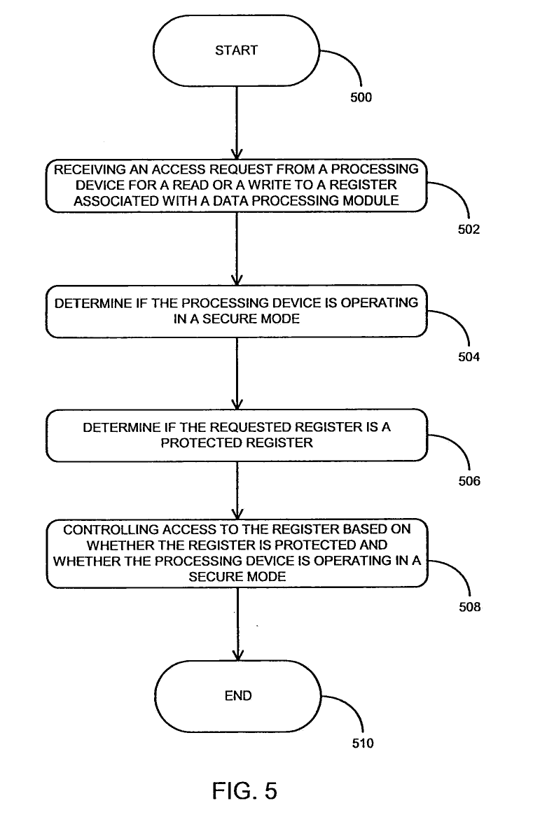

Turning now to FIG. 5, a flowchart shows a method for securing data processing modules operatively connected to a bus. System 200 or integrated circuit 400 may perform one or more of the steps disclosed herein. Thus, some reference numerals are used below that are used above in describing system 200, but it is understood that these numbers are used as examples only and that any suitable system, device, or integrated circuit may perform the steps.

The method starts in block 500, as shown. As shown in block 502, the method includes receiving an access request from a processing device 102 for a read or write to a register associated with a data processing module, such as a peripheral interface 122. As described above in one example, the access request may come from a processing device 102. The access may occur, in one example, by the processing device 102 when executing stored computer readable instructions, i.e., when executing an application. A determination is then made, as shown in block 504, as to whether the processing device 102 making the access request is operating in a secure mode. In one example, the processing device 102 may use one or more security bits to indicated that it is operating in a secured mode. Any other suitable means for indicating or determining whether processing device 102 is operating in a secure mode may be used.

If the processing device 102 is operating in an unsecure mode, then a determination is made as to whether the requested register associated with a peripheral device 122 is a protected register, as shown in block 506. As noted above, a protected register 306 is protected because it is designated as such. Thus, in one example, the address 320 of a protected register 306 is in a register exclusion table 310, and control logic 312 determines if the address of the requested register is in the register exclusion table 310. In another example, control logic 312 may alternatively or additionally determine if the address of the requested register is within a range of registers designated in the secure region of registers 314.

The method then includes, as shown in block 508 before ending in block 510, controlling access to the protected register associated with a peripheral device 122 based on whether the register is protected and whether the processing device 102 is operating in a secure mode. For example, control logic 312 may deny the request, either implicitly by doing nothing or explicitly by sending back a rejection to the processing device 102. Alternatively, control logic 312 may allow access to the requested register.

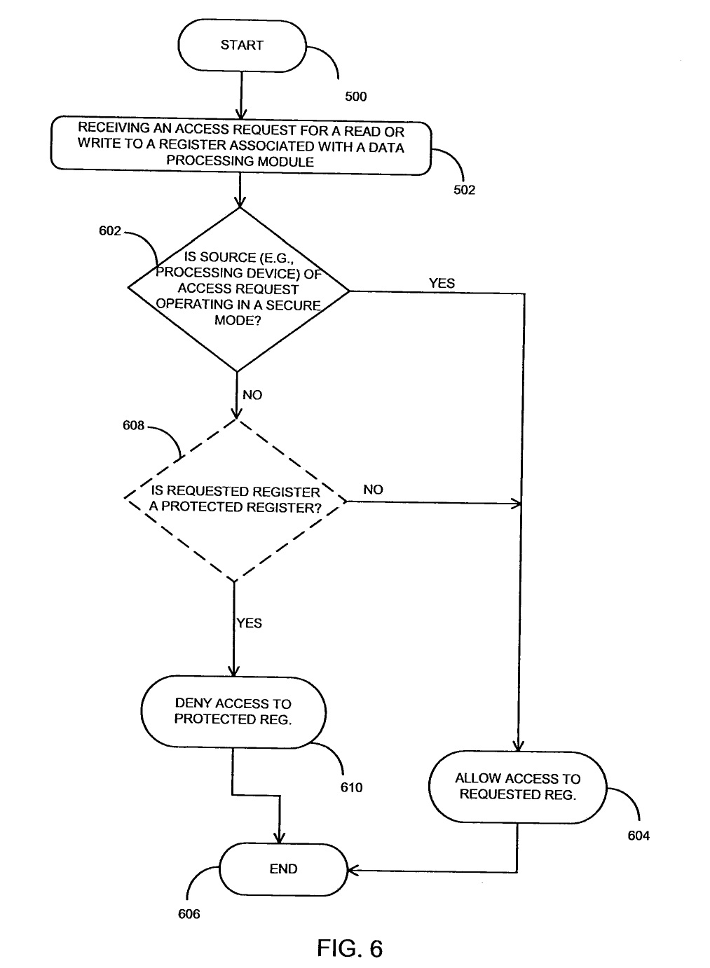

It is understood that the method shown in FIG. 5 may include any additional suitable steps before, after, or between any of the steps shown. It is also understood that the steps may be performed in any suitable order. Another method is shown in FIG. 6, starting in block 600. As shown in block 502, the method includes receiving an access request from a processing device 102 for a read or a write to a register associated with a peripheral interface 122. Then as shown in decision block 602, it is determined whether the source of the access request (e.g., a processing device 102) is operating in a secure mode. If the source of the access request is operating in a secure mode, then the access request may be allowed, as shown in block 604, and then ends in block 606. If the source is operating in an unsecure mode, the method continues as shown in block 608.

In optional block 608, a determination is made as to whether the requested register is a protected register. This may be done by any suitable means. For example, control logic 312 may check a register exclusion table 3 10 to determine if the requested register is listed as a protected register in the register exclusion table 310. Alternatively or additionally, control logic 312 checks a secure region of registers 314 to determine if the requested register is included in a group of registers that are protected. If the requested register is determined to be a protected register, then the access to the at least one register is denied, as shown in block 610 before ending in block 606. Alternatively, if the requested register is not determined to be a protected register, then access is allowed to the requested register, as shown in block 604, before the method ends in block 606.

As noted, the method may be performed in any suitable order and may include any additional steps, as desired. For example, the method may include changing or updating at least one value in the secure region of registers 314 to designate at least one other register, perhaps by designating a range of registers, as being a secure or protected register. This change may be made, for example, when a request for the change is made by a processing device 102 that is operating in a secure mode. The change may be made by any other suitable means when made by a trusted or secure source. If a request for a change is made by an unsecure source, such as a processing device 102 operating in an unsecure mode, the change is not made and may be either ignored or denied.

As will be appreciated by those of ordinary skill in the art, the operation, design, and organization, of a circuit can be described in a hardware description language (“HDL”) such as Verilog™, VHDL, or other suitable hardware description languages. As used herein, the term “circuit” can include an electronic circuit, one or more processors (e.g., shared, dedicated, or group of processors such as but not limited to microprocessors, DSPs, or central processing units), and memory that execute one or more software or firmware programs, combinational logic circuits, an ASIC, and/or other suitable components that provide the described functionality.

As such, a computer readable medium may include information written in a hardware description language that when executed by at least one processor causes the at least one processor to at least one of: operate, design, and organize a circuit that includes the components described throughout. For example, the circuit may include at least a portion of the integrated circuit 400 shown in FIG. 4. The hardware description language may further include information describing the register exclusion table and the values stored therein. Thus, as one skilled in the art will appreciate, a hardware designer may include different information on the computer readable medium to design, operate, or organize a circuit representing a register exclusion table and, as such, may automatically generate a register exclusion table. Thus, a designer may easily design, operate, organize, or simulate different circuits with different levels of protection by changing, adding, or deleting addresses of protected registers from the register exclusion table.

It should be noted that in practicing the security control module 202 disclosed herein, it is often useful to test the security control module 202 after production. To fully test the security control module 202, the security control module may include a fuse 322 operative to permanently enable the security control module when desired. In other words, the security control module 202 may be produced in an unsecure state, such that an accessing client running on an unsecure processing device 102 may access protected registers for testing purposes. However, the fuse 322 may be permanently switched to permanently place the security control module in a secure state such that the security control module 202 may never again operate in an unsecured state. Thus, in practice, a security control module 202 will never be sold to a consumer without being in a secured state. The fuse 322 may, for example, be a fuse, an antifuse, or any other suitable mechanism for permanently placing the security control module 202 in a secured or active state.

As noted above, among other advantages, the system provides a central location for securing data processing modules in a system, such as peripheral interfaces, processing devices, etc. As such, confidential information and/or information subject to copyright laws may be protected without requiring only security-aware data processing modules. By providing a centrally located solution to control access to potentially vulnerable registers, even security-unaware data processing modules may be secured. Other advantages will be recognized by those having ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A system comprising:
a protected register associated with a data processing module; and
a security control module, operatively connected to both a processing device and the protected register associated with the data processing module, operative to control access to the protected register associated with the data processing module.

2. The system of claim 1, wherein the security control module includes:
control logic operatively connected to both the processing device and the data processing module; and
a register exclusion table operatively connected to the control logic.

3. The system of claim 2, wherein the register exclusion table contains at least one representation of an address associated with the protected register.

4. The system of claim 3, wherein the control logic is operative to:
receive an access request to a requested register;
determine if the requested register is included in the register exclusion table as the protected register; and
deny the access request if the requested register is included in the register exclusion table as the protected register and if the processing device is operating in an unsecure mode.

5. The system of claim 1 further including at least one accessing client executing on the processing device and having the ability, as controlled by the security control module, to access the protected register when the processing device is operating in a secure mode but not having the ability to access the protected register when the processing device is operating in an unsecure mode.

6. The system of claim 1 further comprising a secure region of registers corresponding to the data processing module.

7. The system of claim 1, wherein the security control module is implemented in hardware.

8. The system of claim 7 comprising a fuse operative to permanently enable the security control module.

9. An integrated circuit for an electronic system, the integrated circuit comprising:
a processing device interface for operatively connecting to a processing device; and
a security control module operative to control access by the processing device to a protected register associated with a data processing module.

10. The integrated circuit of claim 9, wherein the security control module includes:
control logic operatively connected to the processing device interface; and
a register exclusion table operatively connected to the control logic.

11. The integrated circuit of claim 10, wherein the control logic is operative to:
receive an access request to a requested register;
determine if the requested register is included in the register exclusion table as the protected register; and
deny the access request if the requested register is included in the register exclusion table as the protected register and if the processing device is operating in an unsecure mode.

12. The system of claim 10, wherein the register exclusion table contains at least one representation of an address associated with the protected register.

13. The integrated circuit of claim 9 wherein the security control module allows at least one accessing client, executing on the processing device, access to the protected register when the processing device is operating in a secure mode and denies the at least one accessing client access to the protected register when the processing device is operating in an unsecure mode.

14. The integrated circuit of claim 9 further comprising:
a secure region of registers, operatively connected to the security control module, and operative to designate at least one other register as being protected.

15. A method comprising:
receiving an access request from a processing device for a read or a write to a register associated with a data processing module; and
controlling access to the register associated with the data processing module based on whether the register is protected and whether the processing device is operating in a secure mode.

16. The method of claim 15 wherein controlling access to the register associated with the data processing module includes allowing the processing device to access the register if the processing device is operating in a secure mode.

17. The method of claim 15 wherein controlling access to the register includes denying access to the register if the processing device is operating in an unsecure mode.

18. The method of claim 15 further comprising:
determining whether a secure region of registers corresponding to the data processing module contains a representation of an address associated with the access request.

19. The method of claim 18 further comprising:
changing a value in the secure region of registers to designate at least one other register associated with the data processing module as being the register.

20. The method of claim 19 further comprising:
denying access to the at least one other register if the processing device is operating in an unsecure mode.

21. A computer readable medium comprising information that when executed by at least one processor causes the at least one processor to: at least one of: operate, design, and organize a circuit that comprises:
a processing device interface for operatively connecting to a processing device; and
a security control module operatively connected to the processing device interface and operative to control access to a protected register associated with a data processing module.

22. The computer readable medium of claim 21, wherein the security control module includes:
control logic operatively connected to the processing device interface; and
a register exclusion table operatively connected to the control logic.

23. The computer readable medium of claim 22, wherein the control logic is operative to:
receive an access request to a requested register; and
deny the access request if the requested register is included in a register exclusion table as the protected register and the processing device is operating in an unsecure mode.

24. The computer readable medium of claim 21, wherein the register exclusion table contains at least one representation of an address associated with the protected register.

25. The computer readable medium of claim 21, wherein the security control module is operative to allow at least one accessing client, executing on the processing device, access to the protected register when the processing device is operating in a secure mode and denies the at least one accessing client access to the protected register when the processing device is operating in an unsecure mode.

26. The computer readable medium of claim 21, wherein the circuit further comprises:
a secure region of registers, operatively connected to the security control module, and operative to designate at least one other register as being protected.

27. The computer readable medium of claim 26, wherein the security control module is operative to deny access to the at least one other register designated as protected if the accessing client is associated with the processing device operating in an unsecure mode.
